(19) United States
(12) Patent Application Publication
(10) Pub. No.: US 2021/0114453 A1
(43) Pub. Date: Apr. 22, 2021

(54) METHOD AND APPARATUS FOR CONTROLLING VAPOR RECIRCULATION IN A GASOLINE FUEL TANK

(71) Applicant: Eaton Intelligent Power Limited, Dublin (IE)

(72) Inventor: Vaughn K. Mills, Chelsea, MI (US)

(73) Assignee: Eaton Intelligent Power Limited, Dublin (IE)

(21) Appl. No.: 17/134,823

(22) Filed: Dec. 28, 2020

Related U.S. Application Data
(63) Continuation of application No. PCT/EP2019/025205, filed on Jun. 28, 2019.
(60) Provisional application No. 62/691,016, filed on Jun. 28, 2018.

(51) Int. Cl. B60K 15/035

(52) U.S. Cl. CPC B60K 15/03504; B60K 2015/03557; B60K 2015/0358; B60K 2015/03576; B60K 2015/03566

(57) ABSTRACT

A vent shut-off assembly configured to manage vapor recirculation venting during a refueling event on a fuel tank configured to deliver fuel to an internal combustion engine includes a main housing and an actuator assembly. The main housing selectively vents to a carbon canister. The actuator assembly is at least partially housed in the main housing. The actuator assembly comprises a cam assembly having a cam shaft that includes a first cam and a second cam. The first cam has a profile that actuates a first valve that selectively opens a first port fluidly connected to a first vent in the fuel tank. The second cam has a profile that actuates a second valve that selectively opens a second port fluidly connected to a recirculation line that routes vapor back to a filler neck of the fuel tank.

### CROSS-REFERENCE TO RELATED APPLICATIONS

This application is a continuation of International Application No. PCT/EP2019/025205 filed Jun. 28, 2019, which claims the benefit of U.S. Provisional Application No. 62/691,016 filed Jun. 28, 2018, the contents of which are incorporated herein by reference thereto. The disclosure of the above application is incorporated herein by reference.

### FIELD

The present disclosure relates generally to fuel tanks on passenger vehicles and more particularly to a system that adjusts the flow of vapor in a recirculation line fluidly connected to the upper filler neck.

### BACKGROUND

Fuel vapor emission control systems are becoming increasingly more complex, in large part in order to comply with environmental and safety regulations imposed on manufacturers of gasoline powered vehicles. Along with the ensuing overall system complexity, complexity of individual components within the system has also increased. Certain regulations affecting the gasoline-powered vehicle industry require that fuel vapor emission from a fuel tank's ventilation system be stored during periods of an engine's operation. In order for the overall vapor emission control system to continue to function for its intended purpose, periodic purging of stored hydrocarbon vapors is necessary during operation of the vehicle. In fuel tanks configured for use with a hybrid powertrain it is also necessary to properly vent the fuel tank.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A vent shut-off assembly configured to manage vapor recirculation venting during a refueling event on a fuel tank configured to deliver fuel to an internal combustion engine includes a main housing and an actuator assembly. The main housing selectively vents to a carbon canister. The actuator assembly is at least partially housed in the main housing. The actuator assembly comprises a cam assembly having a cam shaft that includes a first cam and a second cam. The first cam has a profile that actuates a first valve that selectively opens a first port fluidly connected to a first vent in the fuel tank. The second cam has a profile that actuates a second valve that selectively opens a second port fluidly connected to a recirculation line that routes vapor back to a filler neck of the fuel tank.

In other features, the actuator assembly further includes a motor that rotates the actuator assembly. The main housing can be positioned outside of the fuel tank. The cam assembly further includes a third cam having a profile that actuates a third valve that selectively opens a third port fluidly connected to a second vent in the fuel tank. The first cam has a profile that includes a refueling flow profile, a running loss/trickle fill flow profile, and a no flow profile.

In additional features, the second cam has a profile that includes a recirculation flow full profile, a recirculation flow profile and a no flow profile. The actuator assembly rotates the cam shaft based on a signal from a controller that determines a desired flow rate. The controller determines the desired flow rate based on fill rate. The controller further determines the desired flow rate based on at least one of a fuel tank pressure, an ambient temperature and a vehicle grade. The second valve can comprise a dead weight that is selectively urged off of a valve seat by the second cam. The motor can be a direct current motor mounted outboard of the main housing. The motor can be a stepper motor.

A method of controlling vapor flow through a vapor recirculation line during a refueling event on a fuel tank is provided. The method includes determining operating conditions during refueling. A signal is communicated from a controller to a vent shut-off assembly disposed relative to the fuel tank. A first valve on the vent shut-off assembly is opened to a predetermined position. The first valve selectively opens the first port fluidly connected to a first vent in the fuel tank. A second valve is opened on the vent shut-off assembly to a predetermined position. The second valve selectively opens a second port fluidly connected to the recirculation line that routes vapor back to a filler neck on the fuel tank.

In other features, a fill rate of fuel entering the fuel tank is determined. The cam assembly is actuated having a cam shaft that includes a first cam having a profile that actuates a first valve that selectively opens the first port. The first cam can be rotated to a position corresponding to a profile that has a refueling flow profile, a running loss/trickle flow profile and a no flow profile. Opening the second valve can include actuating a cam assembly having a cam shaft that includes a second cam having a profile that actuates the second valve that selectively opens the second port. Actuating the cam assembly comprises rotating the second cam to a position corresponding to a profile that has a recirculation flow full profile, a recirculation flow profile and a no flow profile. Opening the second valve includes actuating a cam assembly having a cam shaft that includes a second cam having a profile that urges a dead weight off of a valve seat.

### BRIEF DESCRIPTION OF THE DRAWINGS

The present disclosure will become more fully understood from the detailed description and the accompanying drawings, wherein:

FIG. 1 is a schematic illustration of a fuel tank system having an evaporative emissions control system including a vent shut-off assembly, a controller, an electrical connector and associated wiring in accordance to one example of the present disclosure;

FIG. 2 is a front perspective view of an evaporative emissions control system including a vent shut-off assembly configured with solenoids according to one example of the present disclosure;

FIG. 3 is an exploded view of the evaporative emissions control system of FIG. 2;

FIG. 4 is a perspective view of a fuel tank system having a vent shut-off assembly and configured for use on a saddle fuel tank according to another example of the present disclosure and shown with the fuel tank in section view;

FIG. 5 is a perspective view of the vent shut-off assembly of the fuel tank system of FIG. 4;

FIG. 6 is a top perspective view of a vent shut-off assembly constructed in accordance to additional features of the present disclosure;

FIG. 7 is a bottom perspective view of the vent shut-off assembly of FIG. 6;

FIG. 8 is a sectional view of the vent shut-off assembly of FIG. 6 taken along lines 8-8;

FIG. 9 is a sectional view of the vent shut-off assembly of FIG. 6 taken along lines 9-9;

FIG. 10 is a front perspective view of a vent shut-off assembly constructed in accordance to another example of the present disclosure;

FIG. 11 is a sectional view of the vent shut-off assembly of FIG. 10 taken along lines 11-11;

FIG. 12 is a sectional view of the vent shut-off assembly of FIG. 10 taken along lines 12-12;

FIG. 13 is an exploded view of the vent shut-off assembly of FIG. 10;

FIG. 14A is a schematic illustration of a fuel tank system constructed in accordance to one example of prior art;

FIG. 14B is a detail view of a filler neck shown during refueling according to one example of prior art;

FIG. 15 is a top perspective view of another vent shut-off assembly constructed in accordance to the present disclosure;

FIG. 16 is a schematic illustration of a fuel tank system incorporating the vent shut-off assembly of FIG. 15 according to one example of the present disclosure; and

FIG. 17 is a cross-sectional view of a cam lobe of the vent shut-off assembly according to additional features of the present disclosure; and

FIG. 18 is a cross-sectional view of a recirculation port according to another example of the present disclosure.

### DETAILED DESCRIPTION

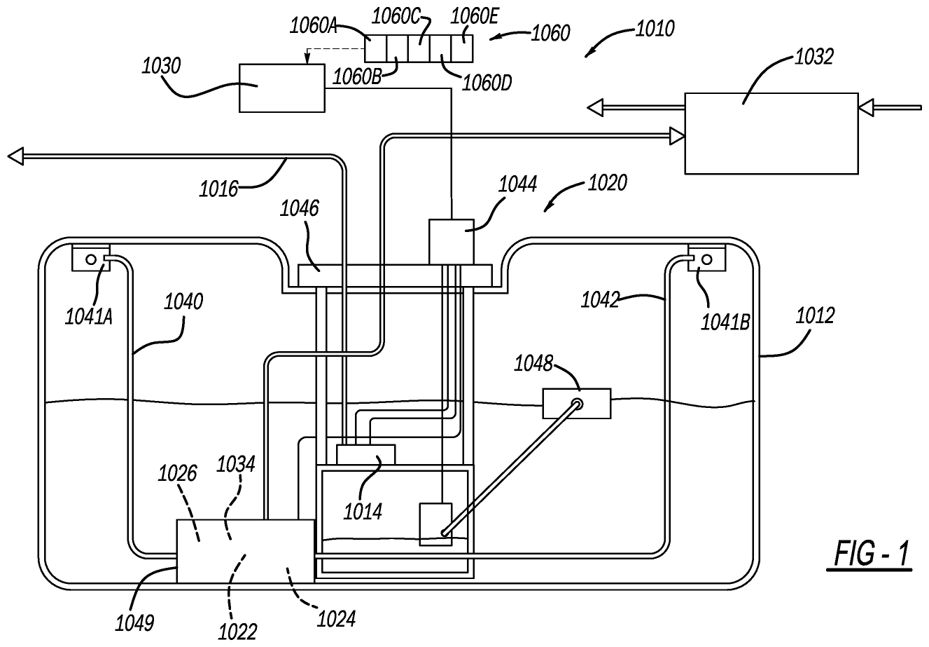

With initial reference to FIG. 1, a fuel tank system constructed in accordance to one example of the present disclosure is shown and generally identified at reference number 1010. The fuel tank system 1010 can generally include a fuel tank 1012 configured as a reservoir for holding fuel to be supplied to an internal combustion engine via a fuel delivery system, which includes a fuel pump 1014. The fuel pump 1014 can be configured to deliver fuel through a fuel supply line 1016 to a vehicle engine. An evaporative emissions control system 1020 can be configured to recapture and recycle the emitted fuel vapor. As will become appreciated from the following discussion, the evaporative emissions control system 1020 provides an electronically controlled module that manages the complete evaporative system for a vehicle.

The evaporative emissions control system 1020 provides a universal design for all regions and all fuels. In this regard, the requirement of unique components needed to satisfy regional regulations may be avoided. Instead, software may be adjusted to satisfy wide-ranging applications. In this regard, no unique components need to be revalidated saving time and cost. A common architecture may be used across vehicle lines. Conventional mechanical in-tank valves may be replaced. As discussed herein, the evaporative control system 1020 may also be compatible with pressurized systems including those associated with hybrid powertrain vehicles.

The evaporative emissions control system 1020 includes a vent shut-off assembly 1022, a manifold assembly 1024, a liquid trap 1026, a control module 1030, a purge canister 1032, an energy storage device 1034, a first vapor tube 1040, a second vapor tube 1042, an electrical connector 1044, a fuel delivery module (FDM) flange 1046 and a float level sensor assembly 1048. The first vapor tube 1040 can terminate at a vent opening 1041A that may include a baffle arranged at a top corner of the fuel tank 1012. Similarly, the second vapor tube 1042 can terminate at a vent opening 1041B that may include a baffle arranged at a top corner of the fuel tank 1012.

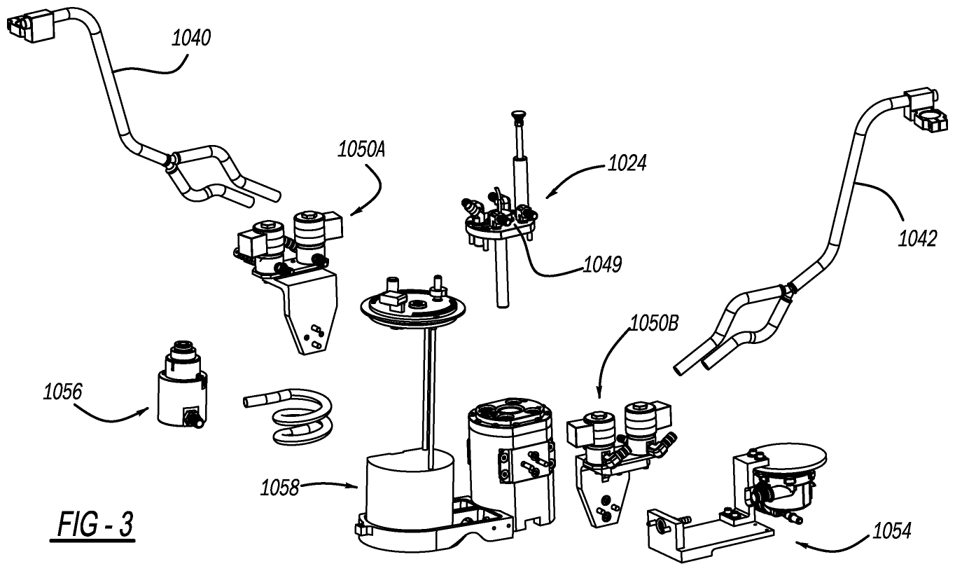

In one example, the manifold assembly 1024 can include a manifold body 1049 (FIG. 3) that routes venting to an appropriate vent tube 1040 and 1042 (or other vent tubes) based on operating conditions. As will become appreciated from the following discussion, the vent shut-off assembly 1022 can take many forms such as electrical systems including solenoids and mechanical systems including DC motor actuated cam systems.

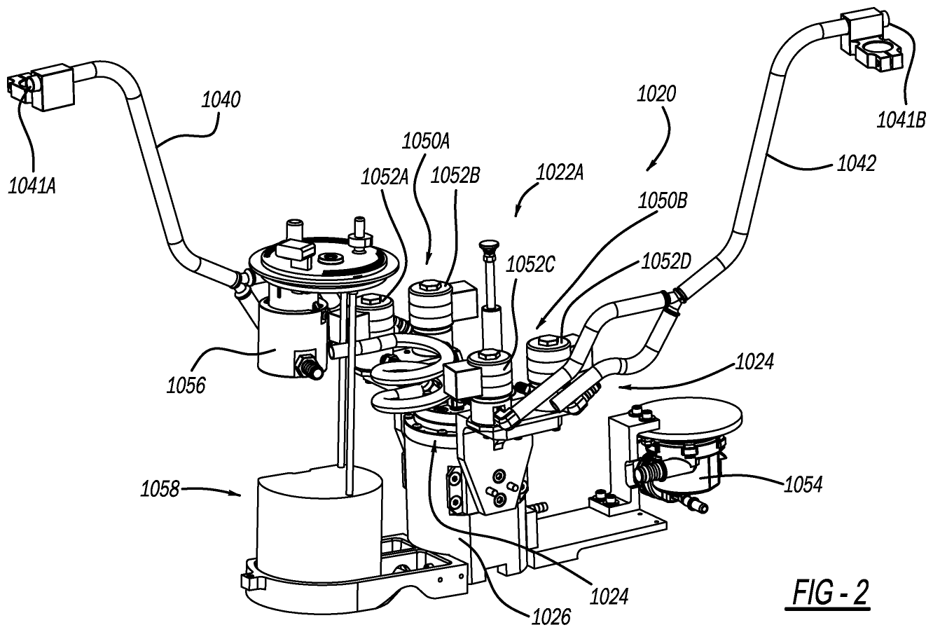

Turning now to FIGS. 2 and 3, a vent shut-off assembly 1022A constructed in accordance to one example of the present disclosure is shown. As can be appreciated, the vent shut-off assembly 1022A can be used as part of an evaporative emissions control system 1020 in the fuel tank system 1010 described above with respect to FIG. 1. The vent shut-off assembly 1022A includes two pair of solenoid banks 1050A and 1050B. The first solenoid bank 1050A includes first and second solenoids 1052A and 1052B. The second solenoid bank 1050B includes third and fourth solenoids 1052C and 1052D.

The first and second solenoids 1052A and 1052B can be fluidly connected to the vapor tube 1040. The third and fourth solenoids 1052C and 1052D can be fluidly connected to the vapor tube 1042. The control module 1030 can be adapted to regulate the operation of the first, second, third and fourth solenoids 1052A, 1052B, 1052C and 1052D to selectively open and close pathways in the manifold assembly 1024, in order to provide over-pressure and vacuum relief for the fuel tank 1012. The evaporative emissions control assembly 1020 can additionally comprise a pump 1054, such as a venturi pump and a safety rollover valve 1056. A conventional sending unit 1058 is also shown.

The control module 1030 can further include or receive inputs from system sensors, collectively referred to at reference 1060. The system sensors 1060 can include a tank pressure sensor 1060A that senses a pressure of the fuel tank 1012, a canister pressure sensor 10608 that senses a pressure of the canister 1032, a temperature sensor 1060C that senses a temperature within the fuel tank 1012, a tank pressure sensor 1060D that senses a pressure in the fuel tank 1012 and a vehicle grade sensor and or vehicle accelerometer 1060E that measures a grade and/or acceleration of the vehicle. It will be appreciated that while the system sensors 1060 are shown as a group, that they may be located all around the fuel tank system 1010.

The control module 1030 can additionally include fill level signal reading processing, fuel pressure driver module functionality and be compatible for two-way communications with a vehicle electronic control module (not specifically shown). The vent shut-off assembly 1022 and manifold assembly 1024 can be configured to control a flow of fuel vapor between the fuel tank 1012 and the purge canister 1032. The purge canister 1032 adapted to collect fuel vapor emitted by the fuel tank 1012 and to subsequently release the fuel vapor to the engine. The control module 1030 can also be configured to regulate the operation of evaporative emissions control system 1020 in order to recapture and recycle the emitted fuel vapor. The float level sensor assembly 1048 can provide fill level indications to the control module 1030.

When the evaporative emissions control system 1020 is configured with the vent shut-off assembly 1022A, the control module 1030 can close individual solenoids 1052A-1052D or any combination of solenoids 1052A-1052D to vent the fuel tank system 1010. For example, the solenoid 1052A can be actuated to close the vent 1040 when the float level sensor assembly 1048 provides a signal indicative of a full fuel level state. While the control module 1030 is shown in the figures generally remotely located relative to the solenoid banks 1050A and 1050B, the control module 1030 may be located elsewhere in the evaporative emissions control system 1020 such as adjacent the canister 1032 for example.

With continued reference to FIGS. 1-3, additional features of the evaporative emissions control system 1020 will be described. In one configuration, the vent tubes 1040 and 1042 can be secured to the fuel tank 1012 with clips. The inner diameter of the vent tubes 1040 and 1042 can be 3-4 mm. In some examples, the poppet valve assembly or cam lobes will determine smaller orifice sizes. The vent tubes 1040 and 1042 can be routed to high points of the fuel tank 1012. In other examples, external lines and tubes may additionally or alternatively be utilized. In such examples, the external lines are connected through the tank wall using suitable connectors such as, but not limited to, welded nipple and push-through connectors.

As identified above, the evaporative emissions control system 1020 can replace conventional fuel tank systems that require mechanical components including in-tank valves with an electronically controlled module that manages the complete evaporative system for a vehicle. In this regard, some components that may be eliminated using the evaporative emissions control system 1020 of the instant disclosure can include in-tank valves such as GVV's and FLVV's, canister vent valve solenoid and associated wiring, tank pressure sensors and associated wiring, fuel pump driver module and associated wiring, fuel pump module electrical connector and associated wiring, and vapor management valve(s) (system dependent). These eliminated components are replaced by the control module 1030, vent shut-off assembly 1022, manifold 1024, solenoid banks 1050A, 1050B and associated electrical connector 1044. Various other components may be modified to accommodate the evaporative emissions control system 1020 including the fuel tank 1012. For example, the fuel tank 1012 may be modified to eliminate valves and internal lines to pick-up points. The flange of the FDM 1046 may be modified to accommodate other components such as the control module 1030 and/or the electrical connector 1044. In other configurations, the fresh air line of the canister 1032 and a dust box may be modified. In one example, the fresh air line of the canister 1032 and the dust box may be connected to the control module 1030.

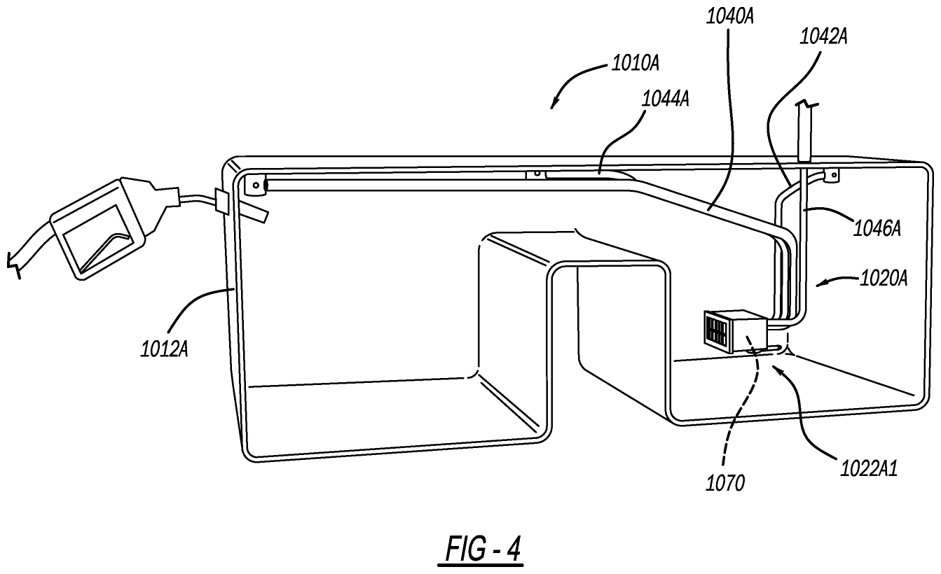

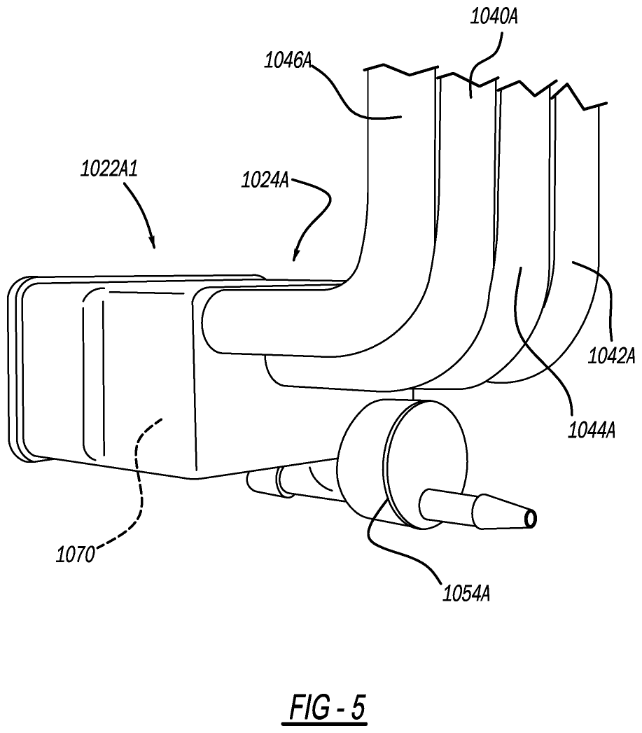

Turning now to FIGS. 4 and 5, a fuel tank system 1010A constructed in accordance to another example of the present disclosure will be described. Unless otherwise described, the fuel tank system 1010A can include an evaporative emissions control system 1020A that incorporate features described above with respect to the fuel tank system 1010. The fuel tank system 1010A is incorporated on a saddle type fuel tank 1012A. A vent shut-off assembly 1022A1 can include a single actuator 1070 that communicates with a manifold 1024A to control opening and closing of three or more vent point inlets. In the example shown, the manifold assembly 1024A routs to a first vent 1040A, a second vent line 1042A and a third vent line 1044A. A vent 1046A routs to the canister (see canister 1032, FIG. 1). A liquid trap and a drain 1054A are incorporated on the manifold assembly 1024A. The fuel tank system 1010A can perform fuel tank isolation for high pressure hybrid applications without requiring a fuel tank isolation valve (FTIV). Further, the evaporative emissions control system 1020A can achieve the highest possible shut-off at the vent points. The system is not inhibited by conventional mechanical valve shut-off or reopening configurations. Vapor space and overall tank height may be reduced.

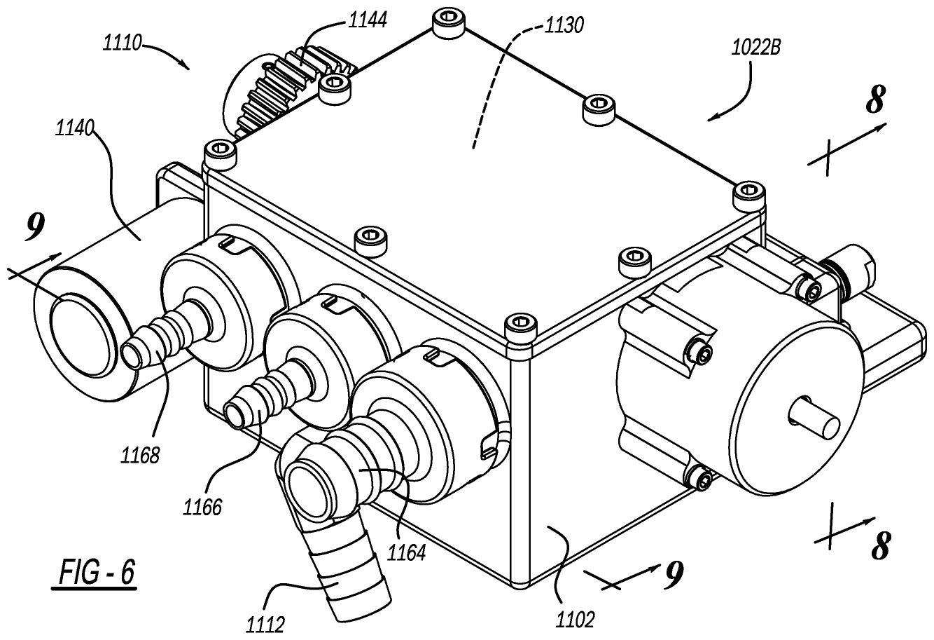

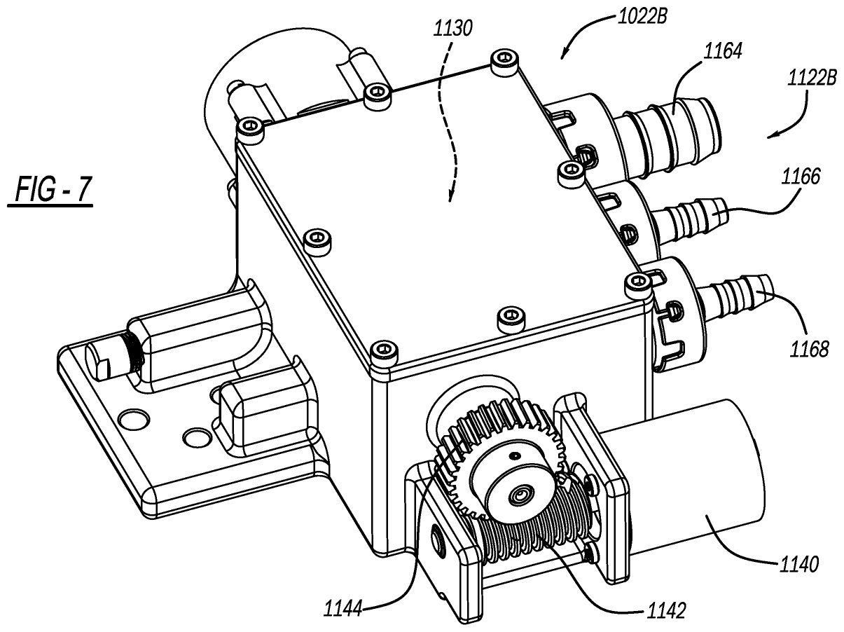

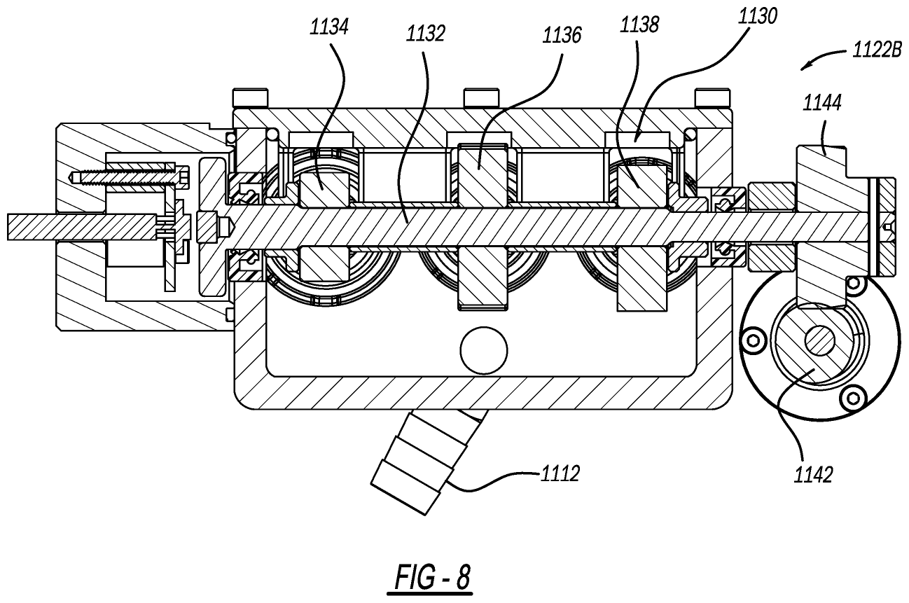

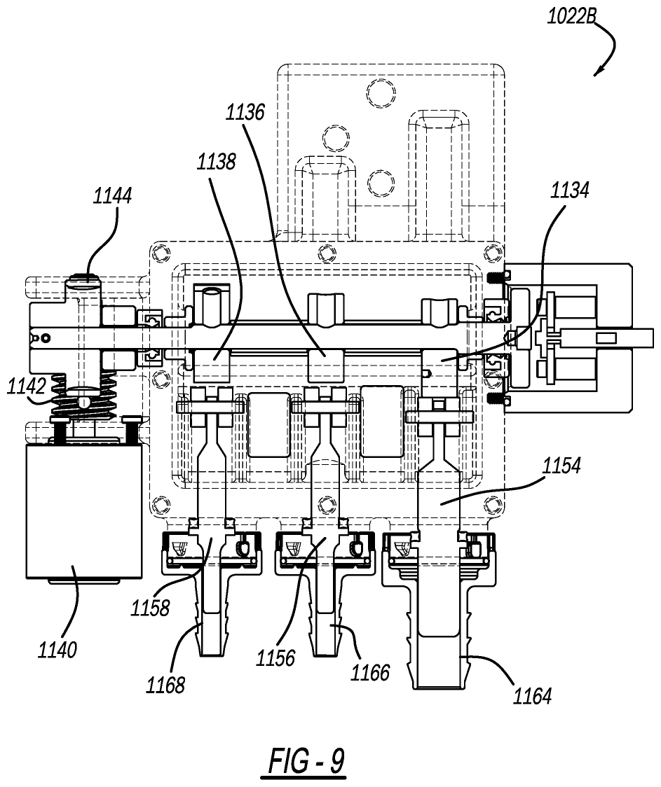

Turning now to FIGS. 6-7, a vent shut-off assembly 1022B constructed in accordance to another example of the present disclosure will be described. The vent shut-off assembly 10228 includes a main housing 1102 that at least partially houses an actuator assembly 1110. A canister vent line 1112 routs to the canister (see canister 1032, FIG. 1). The actuator assembly 1110 can generally be used in place of the solenoids described above to open and close selected vent lines. The vent shut-off assembly 1022B includes a cam assembly 1130. The cam assembly 1130 includes a cam shaft 1132 that includes cams 1134, 1136 and 1138. The cam shaft 1132 is rotatably driven by a motor 1140. In the example shown the motor 1140 is a direct current motor that rotates a worm gear 1142 that in turn drives a drive gear 1144. The motor 1140 is mounted outboard of the main housing 1102. Other configurations are contemplated. The cams 1134, 1136 and 1138 rotate to open and close valves 1154, 1156 and 1158, respectively. The valves 1154, 1156 and 1158 open and close to selectively deliver vapor through ports 1164, 1166 and 1168, respectively. In one example the motor 1140 can alternately be a stepper motor. In other configurations, a dedicated DC motor may be used for each valve. Each DC motor may have a home function. The DC motors can include a stepper motor, a bi-directional motor, a uni-directional motor a brushed motor and a brushless motor. The home function can include a hard stop, electrical or software implementation, trip switches, hard stop (cam shaft), a potentiometer and a rheostat.

In one configuration the ports 1164 and 1166 can be routed to the front and back of the fuel tank 1012. The port 1164 can be configured solely as a refueling port. In operation, if the vehicle is parked on a grade where the port 1166 is routed to a low position in the fuel tank 1012, the cam 1134 is rotated to a position to close the port 1164. During refueling, the valve 1154 associated with port 1164 is opened by the cam 1134. Once the fuel level sensor 1048 reaches a predetermined level corresponding to a “Fill” position, the controller 1030 will close the valve 1154. In other configurations, the cam 1134, valve 1154 and port 1164 can be eliminated leaving two cams 1136 and 1138 that open and close valves 1156 and 1158. In such an example, the two ports 1168 and 1166 can be 7.5 mm orifices. If both ports 1168 and 1166 are open, refueling can occur. If less flow is required, a cam position can be attained where one of the valves 1156 and 1158 are not opened all the way.

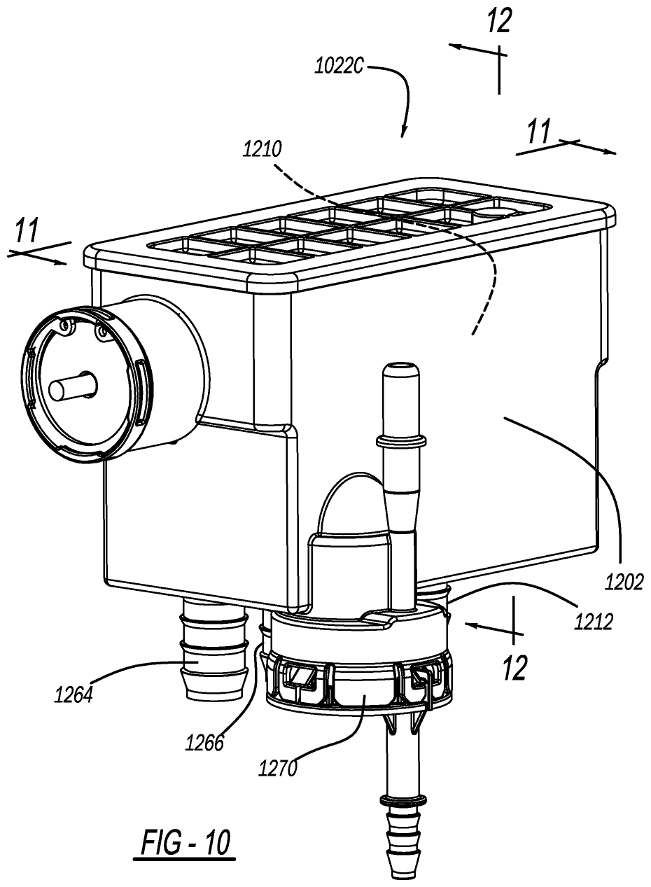

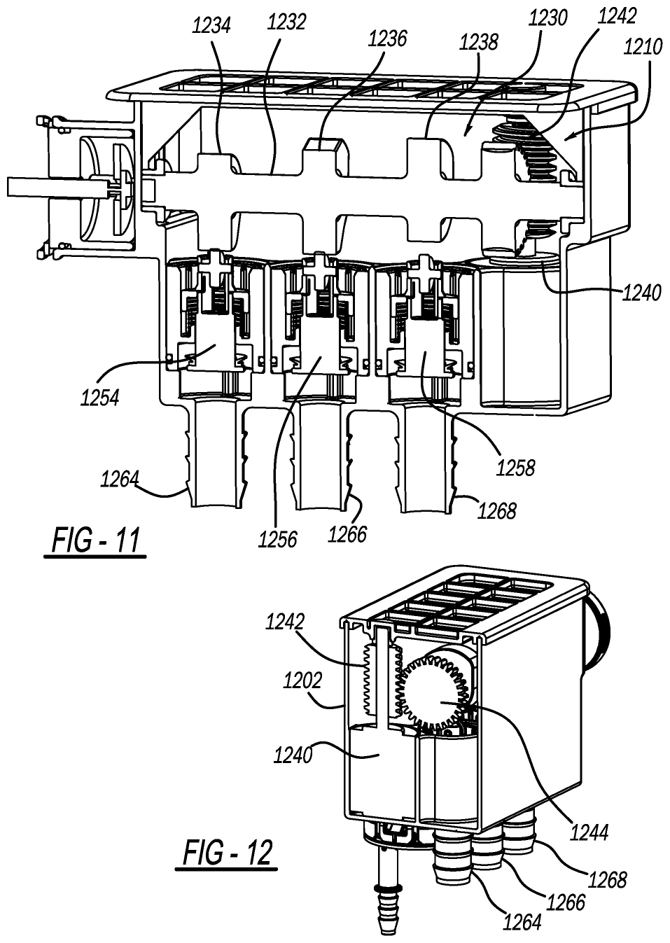

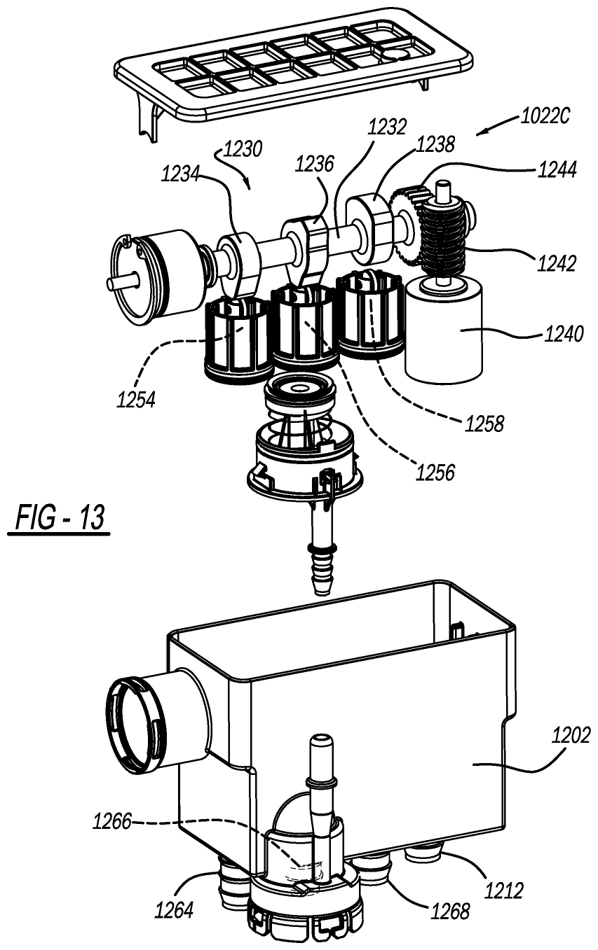

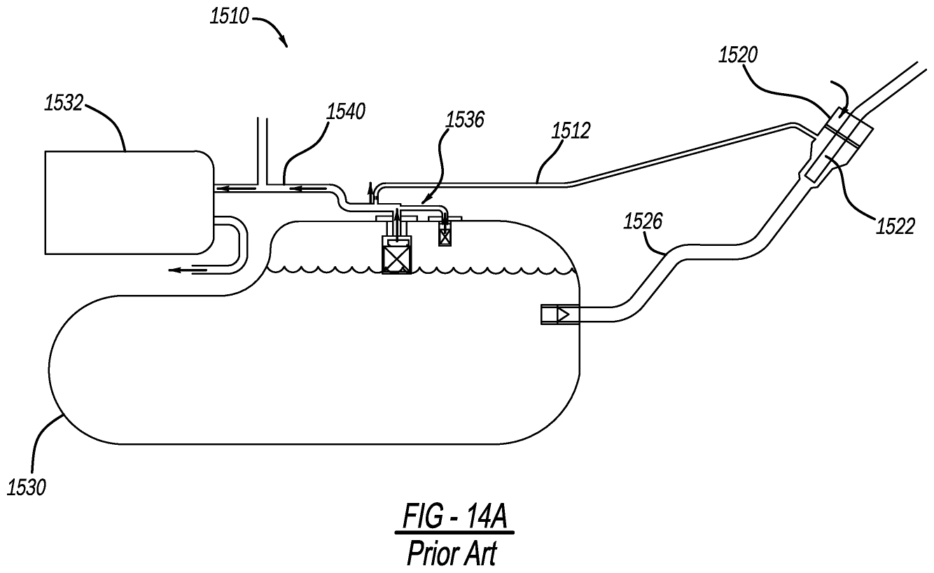

Turning now to FIGS. 10-13, a vent shut-off assembly 1022C constructed in accordance to another example of the present disclosure will be described. The vent shut-off assembly 1022C includes a main housing 1202 that at least partially houses an actuator assembly 1210. A canister vent line 1212 routs to the canister (see canister 1032, FIG. 1). The actuator assembly 1210 can generally be used in place of the solenoids described above to open and close selected vent lines. The vent shut-off assembly 1022C includes a cam assembly 1230. The cam assembly 1230 includes a cam shaft 1232 that includes cams 1234, 1236 and 1238. The cam shaft 1232 is rotatably driven by a motor 1240. In the example shown the motor 1240 is received in the housing 1202. The motor 1240 is a direct current motor that rotates a worm gear 1242 that in turn drives a drive gear 1244. Other configurations are contemplated. The cams 1234, 1236 and 1238 rotate to open and close valves 1254, 1256 and 1258, respectively. The valves 1254, 1256 and 1258 open and close to selectively deliver vapor through ports 1264, 1266 and 1268, respectively. In one example the motor 1240 can alternately be a stepper motor. A drain 1270 can be provided on the housing 1202.

In one configuration the ports 1264 and 1266 can be routed to the front and back of the fuel tank 1012. The port 1264 can be configured solely as a refueling port. In operation, if the vehicle is parked on a grade where the port 1266 is routed to a low position in the fuel tank 1012, the cam 1236 is rotated to a position to close the port 1266. During refueling, the valve 1254 associated with port 1264 is opened by the cam 1234. Once the fuel level sensor 1048 reaches a predetermined level corresponding to a “Fill” position, the controller 1030 will close the valve 1254. In other configurations, the cam 1234, valve 1254 and port 1264 can be eliminated leaving two cams 1236 and 1238 that open and close valves 1256 and 1258. In such an example, the two ports 1268 and 1266 can be 7.5 mm orifices. If both ports 1268 and 1266 are open, refueling can occur. If less flow is required, a cam position can be attained where one of the valves 1256 and 1258 are not opened all the way.

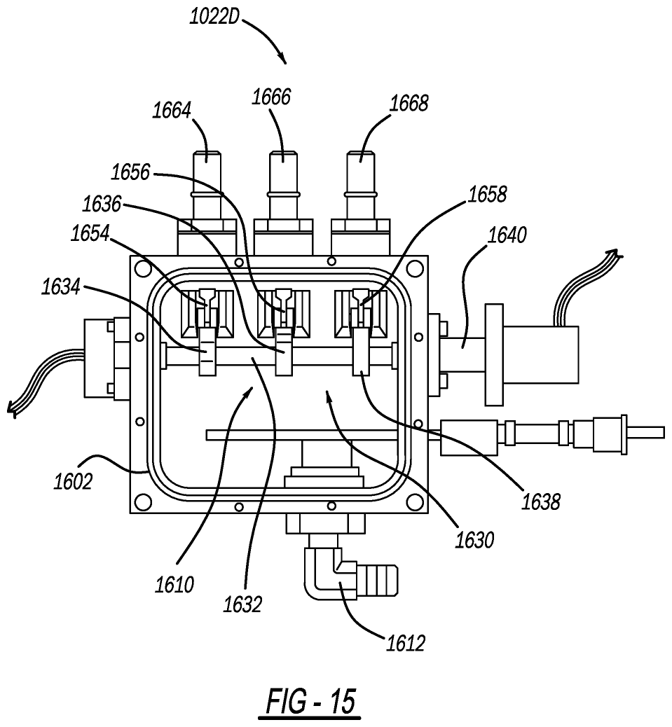

The present disclosure is directed toward a fuel tank system 1600 that incorporates a vent shut-off assembly 1022D (FIG. 15) that is used to control vapor recirculation in a gasoline fuel tank. The vent shut-off assembly 1022D can be configured similar to the vent shut-off assemblies described herein. During refueling, some of the vapor generated in the on-board vapor handling system is recirculated to the upper filler neck. These vapors are then recaptured in the fuel tank via a venturi produced there. The vent shut-off assembly of the present disclosure can be used to adjust the flow of this recirculation line to a desired flow rate.

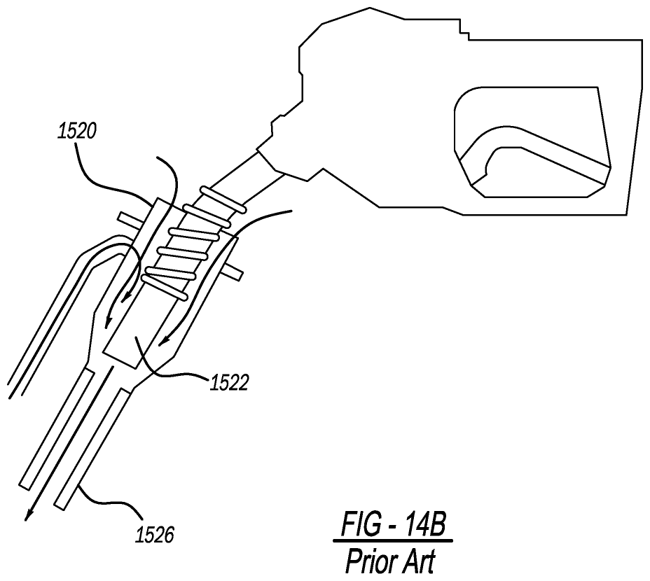

One prior art fuel system constructed in accordance to prior art is shown in FIG. 14A and generally identified at reference 1510. The fuel system 1510 incorporates a recirculation line 1512, and a fill neck or cup 1520 that receives a refueling nozzle 1522. The vehicle fuel system 1510 may also include a fill pipe 1526 for introducing fuel into the fuel tank 1530 and a vapor recovery system (e.g., vapor canister) 1532 to which fuel vapor is vented from the fuel tank 1530 through a valve 1536 and a vent line 1540. When the fuel level in the tank 1530 is below the valve 1536, the valve 1536 may be open and may provide high volume venting of fuel vapor to vapor recovery system 1532. When liquid fuel reaches the valve 1536, the valve 1536 may respond by closing, thereby shutting off flow to the vapor recovery system 1532.

FIG. 14B illustrates an exemplary refueling event using the fuel system 1510. Such prior art systems have recirculation lines that define a fixed orifice. In other words, recirculation line 1512 has a fixed diameter for venting. Usually the diameter is fixed (designed) for the worst case scenario. Because the recirculation line 1512 is fixed for the worst case scenario, some refueling conditions will draw air into the fuel system inefficiently. Air drawn into the fill neck 1520 is about 15% of the liquid fuel input. Fuel vapor is permitted to be recirculated through the recirculation line 1512. This can reduce the overall charcoal canister vapor loading during a refueling event. This is always a balancing act.

The rate of dispensed fuel from the nozzle 1522 dictates how much vapor from the recirculation line 1512 can be entrained back into the fuel tank 1530. Fuel vapor that would otherwise be directed through vent line 1540 to the carbon canister 1532 is recirculated back through recirculation line 1512 into the filler neck 1526. Loading of the carbon canister is reduced by recirculating fuel vapor through the recirculation line 1512. If the orifice size (flow rate) of the recirculation line 1512 is too large, the operator may emit vapors to the atmosphere and an EPA (United States) test for onboard refueling vapor recovery (ORVR) refueling. The present disclosure utilizes the vent shut-off assembly apparatus and controls described above to dispense vapors to the filler neck 1526 at a known rate.

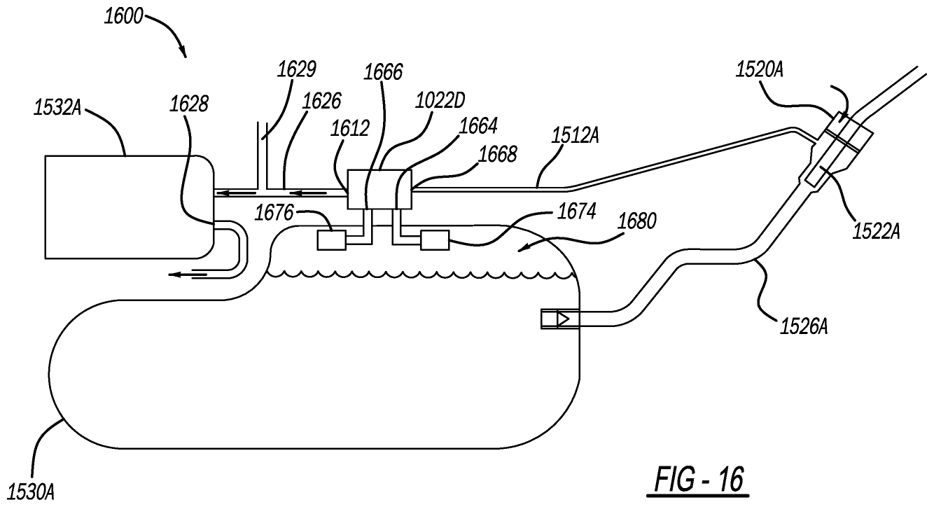

Turning now to FIGS. 15 and 16, a vent shut-off assembly constructed in accordance to additional features of the present disclosure is shown and generally identified at reference 1022D. The vent shut-off assembly 1022D is shown incorporated onto a fuel system 1600. As will become appreciated from the following discussion, the vent shut-off assembly 1022D can be used to open and close a vent path to a certain orifice size at the recirculation line 1512A. The fuel system 1600 includes a fill neck 1520A. Fuel vapor is permitted to be recirculated through the recirculation line 1512A. The rate of dispensed fuel from nozzle 1522A dictates how much vapor from the recirculation line 1512 can be entrained back into the fuel tank 1530A. Fuel vapor that would otherwise be directed through vent line 1626 to the carbon canister 1532A is recirculated back through the recirculation line 1512A into the filler neck 1526A. The configuration shown in FIG. 16 incorporates an externally mounted vent shut-off assembly 1022D however the vent shut-off assembly 1022D can alternatively be disposed within the fuel tank 1530A.

The vent shut-off assembly 1022D includes a main housing 1602 that at least partially houses an actuator assembly 1610. An outlet port 1612 is fluidly connected to the carbon canister 1532A by way of a vent line 1626. The carbon canister 1532A can have an outlet 1628 that selectively vents to atmosphere. The vent line 1626 can also have an outlet 1629 to an engine for engine purge.

The vent shut-off assembly 1022D includes a cam assembly 1630. The cam assembly 1630 includes a cam shaft 1632 that includes cams 1634, 1636 and 1638. The cam shaft 1632 is rotatable driven by a motor 1640. In the example shown the motor 1640 is a direct current motor. The motor 1640 is mounted outboard of the main housing 1602. Other configurations are contemplated. The cams 1634, 1636 and 1638 rotate to open and close valves 1654, 1656 and 1658, respectively.

The valves 1654, 1656 and 1658 open and close between fully open and fully closed positions (and to positions therebetween) to selectively deliver vapor through ports 1664, 1666 and 1668, respectively. It is appreciated that the relative sizes of the valves 1654, 1656 and 1658 as well as the ports 1664, 1666 and 1668 can be configured differently. For example, the recirculation valve 1658 and port 1668 can be smaller than the others. One of the valves 1654 and 1656 and respective ports 1664 and 1666 can be configured as a refueling port and be larger relative to the remaining valve and ports. In one example the motor 1640 can alternately be a stepper motor. In other configurations, a dedicated DC motor may be used for each valve.

In the example shown, the port 1664 is fluidly connected to a first vent 1674 in the fuel tank 1530A. The port 1666 is fluidly connected to a second vent 1676 in the fuel tank 1530A. In some examples, the poppet valve 1656 and port 1666 can be optional. In such instances only one valve 1654 and port 1664 is used to communicate vapor between the vent shut-off assembly 1022D and the vapor space 1680 of the fuel tank 1530A. In some implementations, more than one vent can be incorporated in the vapor space 1680 of the fuel tank 1530 that merge into a common port on the vent shut-off assembly 1022D. Other configurations are contemplated. The port 1668 is fluidly connected to the recirculation line 1512A.

A controller (such as controller 1030 described above) determines the desired flow rate or orifice size preferred at the ports 1664, 1666 and 1668 based on various operating inputs and communicates a signal to the actuator assembly 1610 to open and close the valves 1654, 1656 and 1658 at the optimal position. The controller can determine the optimal flow rate desired through the recirculation line 1512A based on operating conditions such as, but not limited to, fill rate, tank pressure, temperature, and vehicle grade. In this regard, the valve 1658 can be actuated to a desired position to control the desired amount of flow that is routed out of the port 1668 and through the recirculation line 1512A.

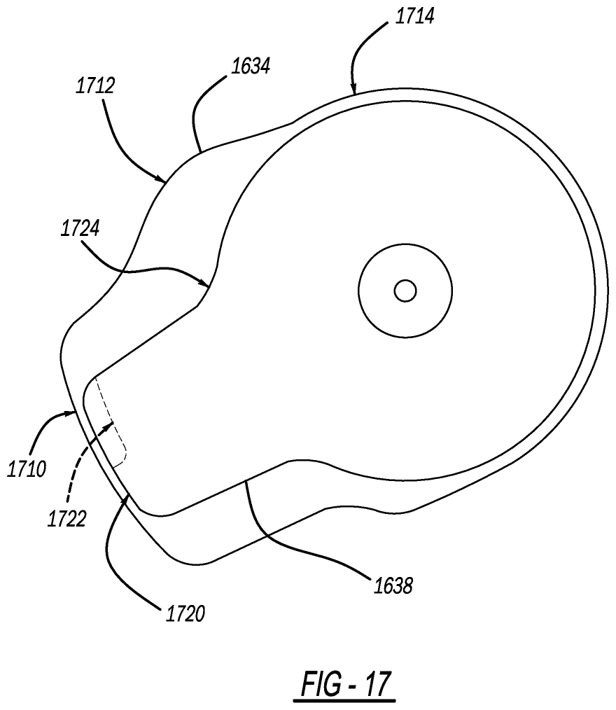

Turning now to FIG. 17, an exemplary profile of the cam 1634 is shown. The cam 1634 has a refueling flow profile 1710, a running loss/trickle fill flow profile 1712 and a no flow profile 1714. Other profiles are contemplated. An exemplary profile of the vapor recirculation cam 1638 is also shown. The cam 1638 has a recirculation flow full profile 1720, a recirculation flow profile 1722 and a no flow profile 1724.

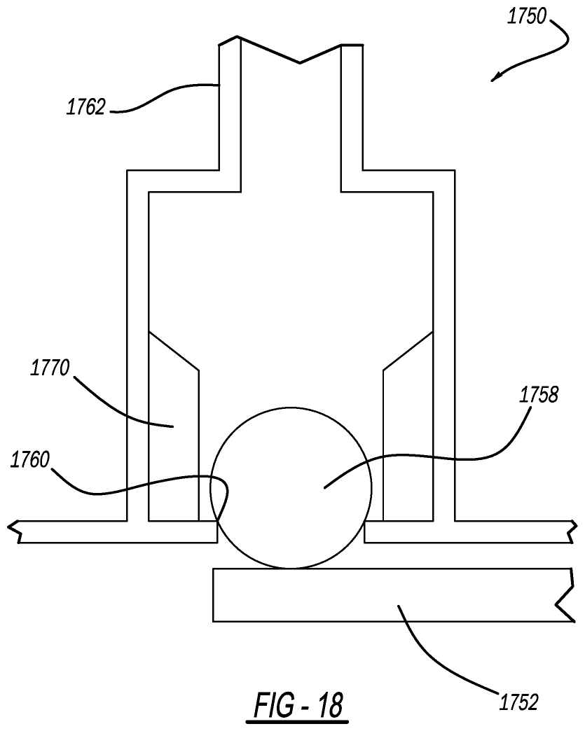

Turning now to FIG. 18 a recirculation port arrangement 1750 constructed in accordance to additional features of the present disclosure is shown. A cam lobe 1752 can be configured to engage a dead weight 1758 to urge the dead weight 1758 off of a seat 1760 to allow flow out of an outlet 1762 for recirculation (into recirculation line 1512A, FIG. 16). Ribbing 1770 is configured to allow flow.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A vent shut-off assembly configured to manage vapor recirculation venting during a refueling event on a fuel tank configured to deliver fuel to an internal combustion engine, the vent shut-off assembly comprising:
a main housing that selectively vents to a carbon canister; and
an actuator assembly at least partially housed in the main housing, the actuator assembly comprising:
a cam assembly having a cam shaft that includes (i) a first cam having a profile that actuates a first valve that selectively opens a first port fluidly connected to a first vent in the fuel tank and (ii) a second cam having a profile that actuates a second valve that selectively opens a second port fluidly connected to a recirculation line that routes vapor back to a filler neck of the fuel tank.

2. The vent shut-off assembly of claim 1 wherein the actuator assembly further includes a motor that rotates the actuator assembly.

3. The vent shut-off assembly of claim 1 wherein the main housing is positioned outside of the fuel tank.

4. The vent shut-off assembly of claim 1 wherein the cam assembly further includes a third cam having a profile that actuates a third valve that selectively opens a third port fluidly connected to a second vent in the fuel tank.

5. The vent shut-off assembly of claim 1 wherein the first cam has a profile that includes a (i) refueling flow profile, (ii) a running loss/trickle fill flow profile, and (iii) a no flow profile.

6. The vent shut-off assembly of claim 1 wherein the second cam has a profile that includes a (i) recirculation flow full profile, (ii) a recirculation flow profile, and (iii) a no flow profile.

7. The vent shut-off assembly of claim 1 wherein the actuator assembly rotates the cam shaft based on a signal from a controller that determines a desired flow rate.

8. The vent shut-off assembly of claim 7 wherein the controller determines the desired flow rate based on fill rate.

9. The vent shut-off assembly of claim 8 wherein the controller further determines the desired flow rate based on at least one of a fuel tank pressure, an ambient temperature and a vehicle grade.

10. The vent shut-off assembly of claim 1 wherein the second valve comprises a dead weight that is selectively urged off of a valve seat by the second cam.

11. The vent shut-off assembly of claim 2 wherein the motor is a direct current motor mounted outboard of the main housing.

12. The vent shut-off assembly of claim 2 wherein the motor is a stepper motor.

13. A method of controlling vapor flow through a vapor recirculation line during a refueling event on a fuel tank, the method comprising:
determining operating conditions during refueling;
communicating a signal from a controller to a vent shut-off assembly disposed relative to the fuel tank;
opening a first valve on the vent shut-off assembly to a predetermined position, the first valve selectively opening a first port fluidly connected to a first vent in the fuel tank; and
opening a second valve on the vent shut-off assembly to a predetermined position, the second valve selectively opening a second port fluidly connected to the recirculation line that routes vapor back to a filler neck on the fuel tank.

14. The method of claim 13 wherein determining operating conditions includes determining a fill rate of fuel entering the fuel tank.

15. The method of claim 13 wherein opening the first valve comprises:
actuating a cam assembly having a cam shaft that includes a first cam having a profile that actuates a first valve that selectively opens the first port.

16. The method of claim 15 wherein actuating the cam assembly further comprises:
rotating the first cam to a position corresponding to a profile that has a (i) refueling flow profile, (ii) a running loss/trickle fill flow profile, and (iii) a no flow profile.

17. The method of claim 13 wherein opening the second valve comprises:
actuating a cam assembly having a cam shaft that includes a second cam having a profile that actuates the second valve that selectively opens the second port.

18. The method of claim 17 wherein actuating the cam assembly further comprises:
rotating the second cam to a position corresponding to a profile that has a (i) recirculation flow full profile, (ii) a recirculation flow profile, and (iii) a no flow profile.

19. The method of claim 13 wherein opening the second valve comprises:
actuating a cam assembly having a cam shaft that includes a second cam having a profile that urges a dead weight off of a valve seat.
